(19) United States
(12) Patent Application Publication
(10) Pub. No.: US 2005/0074178 A1
(43) Pub. Date: Apr. 7, 2005

(54) Method for encoding a video data stream and video encoding device

(76) Inventors: Francesco Montrone, Riemerling (DE); Qinghua Zheng, Taufkirchen (DE)

Correspondence Address: SCHIFF HARDIN LLP;Patent Department, 6600 Sears Tower, 233 South Wacker Drive, Chicago, IL, 60606, US

(21) Appl. No.: 10/955,673

(22) Filed: Sep. 30, 2004

(30) Foreign Application Priority Data
Sep. 30, 2003 (DE) 103 45 441.1

(51) Int. Cl. G06K 9/36

(52) U.S. Cl. 382/240

(57) ABSTRACT

A method and appertaining system operate on digital images that are grouped into a plurality of image groups. Each digital image is subjected to a two-dimensional intra-image wavelet transformation. Further, the digital images of each image group are subjected to an inter-image wavelet transformation. The digital images are encoding using the intra-image wavelet transformation coefficients and the inter-image wavelet transformation coefficients are formed.

### BACKGROUND

The invention relates to a method for encoding a video data stream and also to a video encoding device.

Within the framework of encoding and transmission of a digital video data stream with a plurality of digital images, a block-based spectral transformation is normally used within the framework of source encoding of the digital images, for example, Discrete Cosine Transformation (DCT).

The particular disadvantage of a block-based spectral transformation is that, because of the distribution of the pixels of a digital image into image blocks in each case and the encoding of the encoding information assigned to pixels within an image block (brightness values (luminance values) and/or color values (chrominance values)), “block artifacts” arise during the decoding of the encoded digital images.

A known method of avoiding block artifacts is, within the framework of video compression, i.e., lossy encoding in a sequence of digital images, to use a “wavelet transformation” instead of a block-based spectral transformation.

An overview of the basics of different wavelet transformations and of its applications is disclosed in J. Bergh, F. Ekstedt, M. Lindberg, Wavelets, Studentenliteratur, Lund, ISBN 91-44-00938-0, S. 143 to 1999 (Wavelets, student literature, Lund, ISBN 91-44-00938-0, Pages 123 through 143, 1999).

According to the prior art, it has previously merely been usual to subject the encoding information of pixels with a digital image to a two-dimensional wavelet transformation.

The problem underlying the invention is to address a method for encoding a video data stream as well as a video encoding device which makes improved scaling of the scaling of a video data stream possible, such as can be achieved with the known method using a wavelet transformation.

### SUMMARY

The problem is resolved by a method for encoding a video data stream with a plurality of digital images, comprising: grouping the digital images into a plurality of image groups, with each image group featuring a plurality of digital images, and where each digital image features a plurality of pixels to which encoding information is assigned; subjecting each digital image to a two-dimensional intra-image wavelet transformation, with the encoding information of one image in each case being transformed, with which intra-image wavelet transformation coefficients are generated; storing the intra-image wavelet transformation coefficients; subjecting the digital images of each image group to an inter-image wavelet transformation, with the encoding information of all images of the relevant image group being transformed, with which inter-image wavelet-transformation coefficients are formed; storing the inter-image wavelet-transformation coefficients; and encoding the digital images using the intra-image wavelet transformation coefficients and the Inter-image wavelet transformation coefficients. The problem is also resolved by an apparatus comprising a processor for executing the method and a first and second memory store configured to store the intra-image wavelet transformation coefficients and the inter-image wavelet transformation coefficients respectively, where the first and second memory stores may or may not be present on separate physical memory devices.

With a method for encoding a video data stream with a plurality of digital images, the digital images are grouped into a plurality of image groups, where each image group features a plurality of digital images. The different image groups can contain the same number of digital images or a different number of digital images. Each digital image features a plurality of pixels, to each of which encoding information is assigned, for example, brightness information (luminance information) and/or color information (chrominance information).

With the method, each digital image is subjected to a two-dimensional intra-image wavelet transformation, with the encoding information of one digital image in each case being transformed, with which intra-image wavelet transformation coefficients are formed. This two-dimensional intra-image wavelet transformation corresponds to the wavelet transformation of a digital image known per se within the framework of video encoding.

The intra-image wavelet transformation coefficients are stored in accordance with embodiments of the invention discussed below. Further the digital images of each image group are subjected to an inter-image wavelet transformation, in which case the encoding information of all images of the relevant image group will be transformed, which forms inter-image wavelet transformation coefficients. The inter-image wavelet transformation coefficients generated are stored.

The pixels which are located locally at the same position within the digital images of all images of an image group are subjected to a joint wavelet transformation, so that, for example, the encoding information of the first pixel of the digital images in each case at the left top edge of the images of an image group in each case is transformed in each case to form an inter-image wavelet transformation coefficient, then the encoding information of all pixels of the digital images of a relevant image group which is assigned to the pixel of the second column in the first line of the digital images, etc.

The inter-image wavelet transformation and the intra-image wavelet transformation can be embodied as a common three-dimensional transformation, in which case a common three-dimensional wavelet transformation is performed on a group of images in each case. If the wavelets are separable, the inter-image wavelet transformation and the intra-image wavelet transformation can be embodied as two transformations.

The result of the three-dimensional wavelet transformation is thus a three-dimensional matrix of wavelet transformation coefficients which contain the location encoding and the time encoding. For this reason the data format created can be designated as a “uniform” data format.

This forms a timing compression of the digital video data of a video data stream within the framework of the video encoding using a wavelet transformation. The inter-image wavelet transformation coefficients generated are stored. The digital images are encoded using the intra-image wavelet transformation coefficients and the inter-image wavelet transformation coefficients, preferably employing quantizing, entropy encoding and/or run length encoding.

The intra-image wavelet transformation coefficients and the inter-image wavelet transformation coefficients form for each image group a three-dimensional wavelet transformation coefficient matrix, whereby n*m*K wavelet transformation coefficients are contained the matrix in each case, with n designating the number of rows within a digital image, m the number of columns of a digital image and K the number of digital images within an image group.

By using the three-dimensional wavelet transformation coefficient matrix formed in this way, a uniform, context-free data format for encoding and transmission of video signals with any given interactive, continuous scaling option and phasing option is created, as explained in more detail below.

The data format is context-free, since no additional information is used or is created, for example, no additional information for description of movement vectors for specified image sections.

Since it is now also possible to achieve video compression regarding timing redundancy, a dynamic balancing out of the required communication power and computing power of the processing time for encoding and transmission of video data as well as the scope of data to be encoded and transmitted and the data resolution of the video data stream is achieved, even regarding the redundancy of the encoding information in chronologically consecutive images.

A further advantage is avoiding the block artifacts which would occur were block based spectral transformations to be used during video encoding.

Further, the use of wavelet transformations has the advantage that “multiresolution technology” can be employed.

Thus, there is a clear spatial and/or temporal encoding of the wavelets, i.e., the relevant wavelet transformation coefficients.

Advantageous uses include the area of video compression, preferably within the framework of communication, i.e., the encoding and transmission of three-dimensional video image data (for example, in a distributed development environment, within the framework of Communication on Air), within the framework of visualization (computer tomography visualization, telemedicine, telemonitoring) as well as the modeling and computation of digital image objects (for example, within the framework of modeling and computation of a virtual technical system or within the framework of a multiscale system).

A video encoding device features a processor which is set up so that it can perform the steps listed above. Further, at least one memory is provided in the video encoding device in which the intra-image wavelet transformation coefficients and the inter-image wavelet transformation coefficients can be stored.

The relevant wavelet transformations or the joint three-dimensional wavelet transformation can be applied directly to the encoding information of a relevant pixel, or alternately to difference information for example to the difference between the encoding information of two locally adjacent pixels or to the difference between the encoding information of two directly chronologically consecutive images (of the same relative pixel in each case within the relevant digital image) or a relevant wavelet transformation can be applied to already-transformed wavelet transformed encoding information, i.e., to already formed wavelet transformation coefficients. Thus, for example, the inter-image wavelet transformation can be applied to the formed intra-image wavelet transformation coefficients of the digital images of a group of images in each case.

A one-dimensional wavelet transformation is preferably used as the inter-image wavelet transformation.

An embodiment of the invention provides for just the intra-image wavelet transformation coefficients with a value greater than at least one prespecified location encoding threshold value to be transmitted. This embodiment of the invention can clearly be understood as a local quantization of the wavelet transformation coefficients formed which relate to image information within the digital image. The location encoding threshold value preferably has a variable setting.

Another embodiment of the invention provides for only the inter-image wavelet transformation coefficients with values greater than at least one prespecified time encoding threshold value to be transmitted. This embodiment of the invention can be seen as a chronological quantization of the transformation coefficients, which can be regarded as relating to the changing timing information of the encoding information, which is assigned to the pixels of chronologically consecutive images within an image group. The setting of the time encoding threshold value can also be varied.

Preferably the location encoding threshold value and/or the time encoding threshold value can be set depending on the occupancy level of an output buffer of a video encoding device executing the method so that the quantization becomes coarser when the output buffer is almost full or completely full, and the quantization become more precise, i.e., the resolution becomes greater, when the occupancy level of the output buffer is sufficiently small.

An embodiment of the invention provides for the length of the information to be transformed of each image group to be equal to or greater than the carrier length of the three-dimensional wavelet transformation function, i.e., the inter-image wavelet transformation coefficients and the intra-image wavelet transformation coefficients.

Thus, for example, within the three-dimensional matrices of wavelet transformation coefficients within an image group in the direction of the timing axis, i.e., in the direction of chronologically consecutive images, a flat submatrix will be selected, which means that a pair of individual digital images or, if necessary, segments of individual digital images, will be encoded and transmitted more precisely, i.e., with a greater resolution than the remaining information to be encoded.

Thus up to the carrier length of the wavelet transformation function used, submatricies can be selected explicitly as “Regions of Interest”, to be transmitted at higher resolution for example.

Since the ranges of the “Regions of Interest” can be changed from image group to image group and the specification of the resolution to be used, in other words the quality specification, is continuous, since the threshold values can be set continuously, this approach clearly provides an “interactive scaling and prioritization option”. The quality specification can be adapted to the changes in quality of the transmission channel over time and/or parts of digital images and/or image sequences can be selected/prioritized.

### DESCRIPTION OF THE DRAWINGS

An exemplary embodiment of the invention is shown in the drawings and is described in more detail below.

FIG. 1 is a block diagram of a video data transmission system in accordance with an exemplary embodiment of the invention;

FIG. 2 is a pictorial block flow diagram in which the principle underlying the exemplary embodiment of the invention is clearly shown; and

FIG. 3 is a block diagram showing the dynamically scalable transmission of the video data stream in accordance with an embodiment of the invention.

### DETAILED DESCRIPTION OF THE PREFERRED EMBODIMENTS

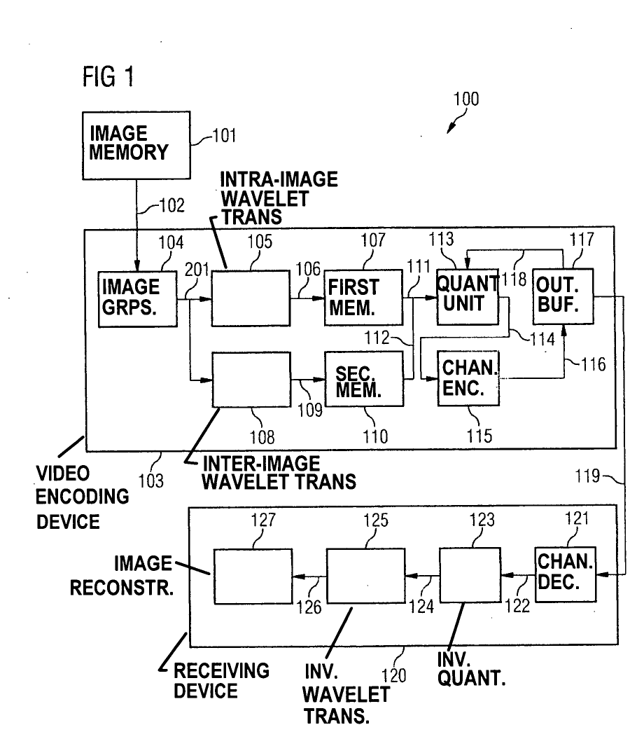

FIG. 1 shows a video data transmission system 100, featuring an image memory 101 which has stored a plurality of chronologically consecutive digital images.

The digital images in the image memory 101 each feature a plurality of pixels arranged in rows and columns to which brightness information (luminance information) and color information (chrominance information) is assigned, in accordance with this exemplary embodiment as per what is known as the YUV color space, which contains encoding information in a ratio of 4:2:2.

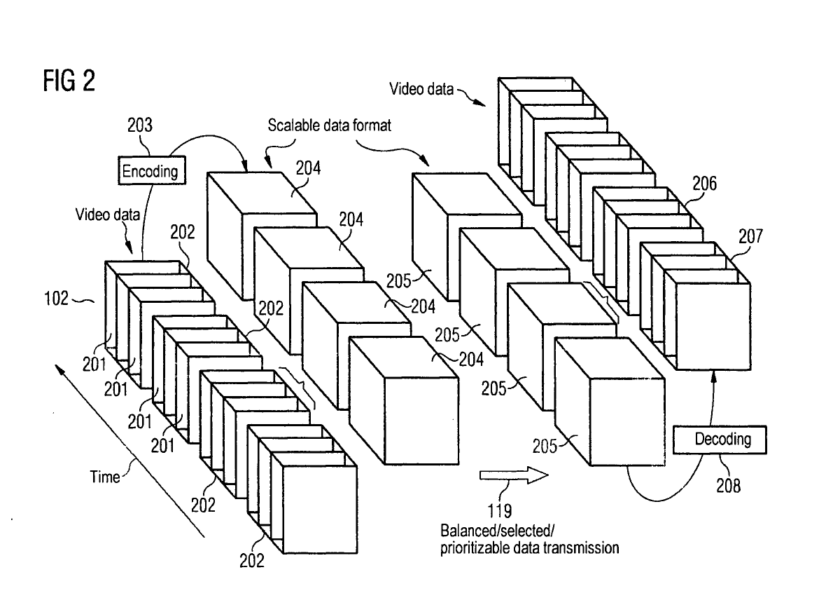

As is shown in FIG. 2, the video data stream 102 features a plurality of digital images 201. The digital images 201 read out of the image memory 101, i.e., the video data stream 102 read out, are fed to a video encoding device 103 and grouped by this into image groups 202 (block 104), with each image group 202 in accordance with this exemplary embodiment of the invention containing K digital images 201. The number K of digital images 201 contained in an image group 202 is greater than or preferably equal to the carrier length of the inter-image wavelet transformation function explained in greater detail below.

After the digital images 201 have been grouped into a plurality of image groups 202 a two-dimensional wavelet transformation known per se is performed independently of the image grouping for each digital image 201, i.e., the encoding information of the pixels of one digital image 201 in each case is subjected to a two-dimensional wavelet transformation, as is known from the prior art. The wavelet transformation of the encoding information of the pixels within a digital image 201 is referred to below as an intra-image wavelet transformation 105.

The result of the intra-image wavelet transformation 105 are intra-image wavelet transformation coefficients 106, which are stored in a first memory 107.

In accordance with this exemplary embodiment of the invention, the intra-image wavelet transformation 105 is thus performed for all digital images 201 of at least one image group 202 in each case and the intra-image wavelet transformation coefficients 106 formed are stored in the first memory 107 as the database for the data matrix described below (encoding 203).

Furthermore, for the digital images 201 of one image group 202, in each case an inter-image-wavelet transformation 108 described in more detail below is performed.

In accordance with this exemplary embodiment of the invention, the intra-image wavelet transformation 105 and the Inter-image-wavelet transformation 108 are performed as a joint three-dimensional wavelet transformation. The separation of the two transformations in the description merely serves to present the invention in simpler terms.

The inter-image-wavelet transformation 108 is undertaken such that the encoding information x_{I, j, k}, where I represents a row index, j a column index and k an image index within an image group 202 (k=1, . . . , K, where K represents the number of digital images 201 within the relevant image group 202) is subjected to a wavelet transformation such that a wavelet transformation coefficient is formed for each pixel in the same local position within the digital images for all digital images 201 within the image group 202.

Expressed in another way, this means that, this exemplary embodiment the invention takes account not only of local redundancy of the encoding information within an image within the framework of encoding but also a “chronological” wavelet transformation of the pixels is performed to exploit the chronological redundancy of the image information on the pixels located locally at the same position within an image in each case in a plurality of digital images 201 each within an image group 202.

The inter-image wavelet transformation coefficients 109 formed by inter-image wavelet transformation 108 in each case are stored in a second memory 110.

Iin this context, the first memory 107 and the second memory 110 can be embodied as a common memory.

The intra-image wavelet transformation coefficients 106 and the inter-image wavelet transformation coefficients 109 are stored in the form of a scalable, uniform and context-free data format in a three-dimensional data matrix 204, as shown in FIG. 2.

Because of the storage of the transformation coefficients which have been formed using a three-dimensional wavelet transformation, it is now possible in a simple way to perform an optimization of data transmission optionally with regard to the following aspects:

Location and resolution (i.e., as quickly as possible);

Location and time (i.e., resolution as high as possible);

Time and resolution (i.e., area as large as possible).

Further in accordance with an embodiment of the invention, it is easily possible to define “Regions of Interest” (RoI) and to encode and transmit these with improved, i.e., increased, resolution.

Within the framework of the encoding of the transformation coefficients 111, 112 read out from the memories 107, 110, these are fed to a quantization unit 113 and quantized in this unit. This means that within the framework of the quantization for each transformation coefficient 111, 112 read out, it is possible to determine whether the value of the transformation coefficients 111, 112 is equal to or greater than the specifiable quantizing threshold value, if a number of quantizing threshold values exist, is equal to or greater than one or more of the specified quantizing threshold values.

In this context, the quantizing threshold value or values can be selected or set as required by a user depending on the optimization requirements, as specified above with regard to the different aspects of optimization.

The user can change the quantizing threshold value or the quantizing threshold values at any time depending on the desired spatial and chronological resolution.

There are preferably different quantizing threshold values provided for quantizing the intra-image wavelet transformation coefficients 111 read out (location encoding threshold value(s)) and for the quantizing of the inter-image wavelet transformation coefficients 112 read out (time-encoded threshold value(s)) which can be set independently.

The quantized transformation coefficients 114 are subsequently fed to a channel encoding unit 115 in which the quantized transformation coefficients 114 are subjected to entropy encoding and bitstream realization.

According to this exemplary embodiment, entropy encoding is undertaken in the form of Huffman encoding and run length encoding.

The channel-coded transformation coefficients 116 are stored in an output buffer 117 and transmitted over a transmission channel 119 to a receive device 120.

Depending on the occupancy of the output buffer 117 there is provision in accordance with this exemplary embodiment of the invention that for the case in which the occupancy level of the output buffer 117 exceeds a specified threshold value, referred to below as the buffer threshold value, a control signal 118 is output to the quantizing unit 113, with which a modification of the quantizing threshold value in the quantizing unit 113 is allocated. This is undertaken such that the resolution selected is coarser, i.e., the quantizing threshold value or values are greater, the higher the occupancy level of the output buffer 117 and vice versa.

After transmission of the channel-coded transformation coefficients 116 to the receiver station 120, channel decoding is undertaken in a channel decoder 121, with channel-coded transformation coefficients 122 being formed which are fed to an inverse quantizing unit 123.

As shown in FIG. 2, the channel-decoded transformation coefficients received by the receiver station 120 are clearly present in the form of three-dimensional data matrices 205 which contain the channel-decoded transformation coefficients 122. In the inverse quantizing unit 123, inverse quantizing of the channel-decoded transformation coefficients 122 is undertaken, with which inverse quantized transformation coefficients 124 are formed, which are fed to a unit for inverse wavelet transformation 125 in which, for the wavelet transformation used in the video encoding device 103, inverse wavelet transformation is executed on the inverse quantized transformation coefficients 124.

The reconstructed transformation coefficients 126 formed in this way are fed to an image reconstruction unit 127 by which the digital images are reconstructed and output for a user on a display for example (decoding 208).

The reconstructed digital images 206 are naturally also reconstructed in accordance with this exemplary embodiment of the invention into reconstruction image groups 207.

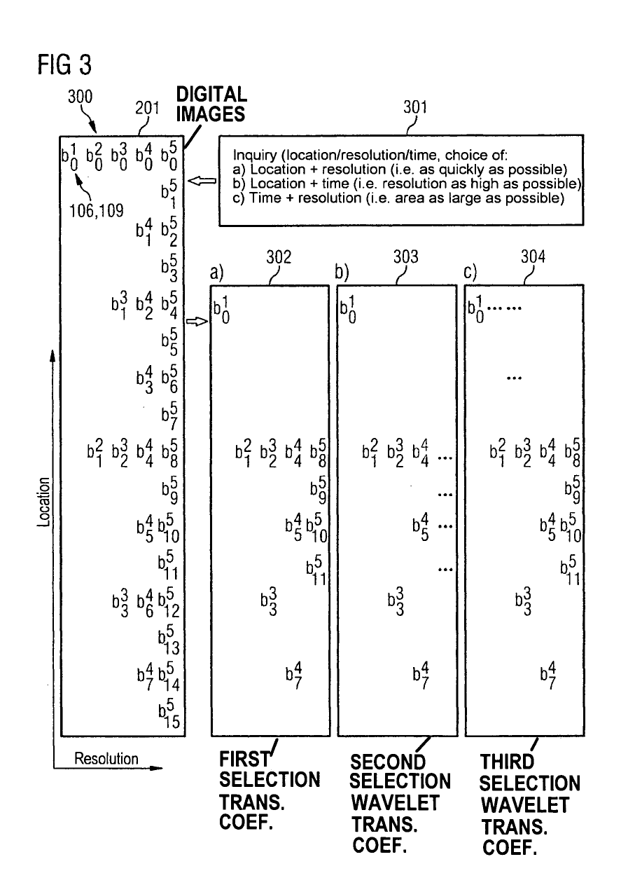

FIG. 3 shows a schematic block diagram 300 of the dynamically scalable (one-dimensional) image date transmission in accordance with the exemplary embodiment of the invention described above, which shows how, from a digital image 201 in which the wavelet transformation coefficients 106, 109 are shown, the relevant inquiry 301 is selected and, depending on the optimization selected and within the framework of the selected optimization aspect (location+resolution/location+time/time+resolution) and the specified local coding threshold value or values associated with it in each case is selected and quantized and subsequently transmitted to the receive device 120 via the physical channel 119, for example, over an air interface.

In this context, FIG. 3 shows a first selection 302 of transformation co-efficients according to the first optimization aspect (location+resolution). The aim of this optimization is the shortest possible transmission time, because, for example, the transmission medium only provides a narrow bandwidth and only an overview of the entire file is required, before individual scenes are selected later for a more detailed transmission. Concessions are made in this case to the resolution that can be achieved. The transmission time is to be reduced, which is also the requirement for a real-time transmission, namely to (first) transmit the most important information in a specified time.

Further a second selection 303 of wavelet transformation coefficients 106, 109 is shown in accordance with the second optimization aspect (location+time). The aim in this case is the highest possible quality for the transmitted film, if for example, a film is first transmitted and then watched later. Concessions are made in this case to the transmission time needed. Furthermore concessions in the resolution are conceivable in this case.

Further, a third selection 304 of wavelet transformation coefficients 106, 109 is shown in accordance with the third optimization aspect (time+resolution). The aim in this case is the greatest possible proportion of film with only slight reductions in the achievable resolution. Concessions are made in this case to the extent where, for example, not all film scenes or, for example, not the entire image, but just a section of the image around the center of the digital images without the edge of the image, will be transmitted.

In summary, this can be seen as making possible dynamic balancing of available bandwidth, transmission time and scope of data. Thus, real-time applications with the maximum possible scope of data, prescribed data resolution with maximum possible speed and the integration of the data transmission into an environment, for example, of a local communication network (Local Area Network, LAN), a public communication network (Wide Area Network, WAN) and a radio communication network (Communication on Air, CoA), are made possible.

Further, in accordance with embodiments of the invention, a local location-dependent and time-dependent balancing of the transmission of transformation coefficients is made possible for the first time. This creates the option of a local speed-dependent selection of the transmission type as well as a local structure-dependent choice of resolution.

Within the framework of the representation of location/frequency, in accordance with embodiments of the invention, an interactive option for a zoom-in function or zoom-out function with the same scope of data is guaranteed.

Through a variable decomposition algorithm or a variable family of decomposition algorithms within the framework of wavelet transformations a significant flexibility is achieved in adaptation to different applications, as has been described above.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method for encoding a video data stream with a plurality of digital images, comprising:
grouping the digital images into a plurality of image groups, with each image group featuring a plurality of digital images, and where each digital image features a plurality of pixels to which encoding information is assigned;
subjecting each digital image to a two-dimensional intra-image wavelet transformation, with the encoding information of one image in each case being transformed, with which intra-image wavelet transformation coefficients are generated;
storing the intra-image wavelet transformation coefficients;
subjecting the digital images of each image group to an inter-image wavelet transformation, with the encoding information of all images of the relevant image group being transformed, with which inter-image wavelet-transformation coefficients are formed;
storing the inter-image wavelet-transformation coefficients; and
encoding the digital images using the intra-image wavelet transformation coefficients and the Inter-image wavelet transformation coefficients.

2. The method in accordance with claim 1, further comprising:
utilizing at least one of brightness information and color information assigned to the pixels as encoding information.

3. The method in accordance with claim 1, further comprising:
utilizing a one-dimensional wavelet transformation as an inter-image-wavelet transformation.

4. The method in accordance with claim 1, further comprising:
transmitting only the intra-image wavelet transformation coefficients for having a value greater than at least one prespecified location-encoding threshold value.

5. The method in accordance with claim 4, further comprising:
creating the location-encoding threshold value so that it can be varied.

6. The method in accordance with claim 1, further comprising:
transmitting only the inter-image wavelet transformation coefficients for having a value greater than at least one prespecified time-encoding threshold value.

7. The method in accordance with claim 6, further comprising:
creating the time-encoding threshold value so that it can be varied.

8. The method according to claim 5, further comprising:
setting the location-encoding threshold value in relation to an occupancy level of an output buffer of a video encoding unit executing the method.

9 The method according to claim 7, further comprising:
setting the time-encoding threshold value in relation to an occupancy level of an output buffer of a video encoding unit executing the method.

10. The method in accordance with claim 1, wherein the number of digital images of each image group is equal to or greater than a carrier length of the inter-image wavelet transformation function.

11. A video encoding device, comprising:
a processor configured to:
encode a video data stream with a plurality of digital images, with the digital images being grouped into a plurality of image groups, with each image group featuring a plurality of digital images, and where each digital image features a plurality of pixels to which encoding information is assigned:
subject each digital image to a two-dimensional intra-image wavelet transformation, with the encoding information of one image in each case being transformed, by which intra-image wavelet transformation coefficients are formed;
the video encoding device further comprising a first memory store configured to store the intra-image wavelet transformation coefficients;
the processor being further configured to:
subject the digital images of each image group to an inter-image wavelet transformation, with the encoding information of all images of the relevant image group being jointly transformed, with which inter-image wavelet transformation coefficients are formed;
the video encoding device further comprising a second memory store configured to store the inter-image wavelet transformation coefficients, the first and second memory stores being: a) present on separate physical memory devices, or b) present on a single physical memory device; and
the processor being further configured to:
encode the digital images using the intra-image wavelet transformation coefficients and the inter-image wavelet transformation coefficients.
